(19) United States
(12) Patent Application Publication
(10) Pub. No.: US 2025/0385639 A1
(43) Pub. Date: Dec. 18, 2025

(54) BEARING ASSEMBLIES AND MULTI-LEG FRAMES FOR SOLAR TRACKER

(71) Applicant: Nextracker LLC, Fremont, CA (US)

(72) Inventors: Abhimanyu Anil Sable, Hyderabad (IN); Jacob Mark Morin, Phoenix, AZ (US)

(21) Appl. No.: 19/215,759

(22) Filed: May 22, 2025

Related U.S. Application Data
(60) Provisional application No. 63/661,119, filed on Jun. 18, 2024.

(51) Int. Cl. H02S 20/32; F24S 30/00; F24S 30/425

(52) U.S. Cl. CPC H02S 20/32; F24S 30/425; F24S 2030/15

(57) ABSTRACT

A solar tracker support frame assembly includes a multi-leg solar tracker support frame and a bearing assembly. The multi-leg solar tracker support frame includes a first frame leg, a second frame leg, and a bridge extending between the first frame leg and the second frame leg. The bearing assembly is at the multi-leg solar tracker support frame, and the bearing assembly is configured to support a torque tube. The bearing assembly includes a bearing sleeve and a torque tube connector. The bearing sleeve includes a first bearing sleeve portion and a hanging bearing sleeve portion. The first bearing sleeve portion interfaces with the bridge, and the hanging bearing sleeve portion extends out from the first bearing sleeve portion below the bridge. The torque tube connector is configured to couple the torque tube to the bearing assembly at least at the hanging bearing sleeve portion below the bridge.

### RELATED APPLICATION

This disclosure claims priority to U.S. Provisional Patent Application No. 63/661,119, filed Jun. 18, 2024, the content of which is hereby incorporated by reference

### TECHNICAL FIELD

This disclosure relates generally to device, system, and method embodiments for solar tracker support frame assemblies and solar tracker bearing assemblies. Certain such embodiments disclosed herein relate to a multi-leg solar tracker support frame (e.g., a solar tracker A-frame) and a solar tracker bearing assembly configured to couple to the multi-leg solar tracker support frame. For instance, certain such embodiments disclosed herein include a bearing assembly that is configured to be mounted at a multi-leg solar tracker support frame to position a torque tube at the bearing assembly below an apex at the multi-leg solar tracker support frame (e.g., below a bridge of the multi-leg solar tracker support frame).

### BACKGROUND

Solar panels can convert sunlight into energy. As an example, solar photovoltaic panels convert sunlight directly into electricity for a variety of applications. Solar panels are generally composed of an array of solar cells, which are interconnected to each other. The cells are often arranged in series and/or parallel groups of cells in series.

Solar tracker systems can be used to dynamically orient a plurality of solar modules, for instance, by moving the solar modules throughout the course of a given day to track the movement of the sun and thereby increase the efficiency and productivity of the solar modules. Typical solar tracker systems installed in the field support the solar modules at the ground surface using a foundation at the ground surface. However, such typical solar tracker systems can necessitate a significant number of components and inter-component connections and fastening members to ultimately install the solar tracker system at the foundation at the ground surface.

### SUMMARY

This disclosure in general describes embodiments of devices, systems, and methods relating to solar tracker bearing assemblies and solar tracker support frame assemblies. Such embodiments disclosed herein include solar tracker support frame assemblies having a multi-leg solar tracker support frame and a hanging bearing assembly at the multi-leg solar tracker support frame. Certain such embodiments disclosed herein relate to a multi-leg solar tracker support frame (e.g., a solar tracker A-frame) that can be adjusted relative to a ground surface, for instance that can be adjusted relative to a ground surface in a north-south direction relative to the ground surface. Certain such additional or alternative embodiments disclosed herein relate to a bearing assembly that is configured to be mounted at a multi-leg solar tracker support frame to position a torque tube at the hanging bearing assembly below an apex at the multi-leg solar tracker support frame (e.g., below a bridge of the multi-leg solar tracker support frame). Thus, such a bearing assembly can be configured to “hang” the torque tube at a location below a bridge of the multi-leg solar tracker support frame such that, when the torque tube is coupled to the bearing assembly, the torque tube passes between two legs of the multi-leg solar tracker support frame and below the bridge of the multi-leg solar tracker support frame.

Such embodiments disclosed herein can be useful in reducing the cost, time, and labor associated with installing a solar tracker system in the field. For example, such embodiments disclosed herein can be adapted for use with a wide variety of foundation types. As another example, these embodiments disclosed herein can help to reduce the cost of solar tracker installation in the field by reducing a number of components and inter-component connections and fastening members necessary to effectively couple a torque tube of a solar tracker system to a hanging-type bearing assembly that is supported by a multi-leg solar tracker support frame at a foundation. And as another example, such embodiments disclosed herein can include the bearing assembly configured to be mounted at a multi-leg solar tracker support frame to position a torque tube at the hanging bearing assembly below an apex at the multi-leg solar tracker support frame. This can lower the elevation of the torque tube and rotational axis of the solar tracker system, which in turn can help to reduce the magnitude of dynamic loads (e.g., wind loads) transferred to the foundation which can help to reduce the cost and complexity associated with foundations that would otherwise need to support the greater magnitude dynamic loads resulting from a higher-elevation positioning of the torque tube.

One embodiment includes a solar tracker support frame assembly. This solar tracker support frame assembly includes a multi-leg solar tracker support frame and a bearing assembly. The multi-leg solar tracker support frame includes a first frame leg, a second frame leg, and a bridge extending between the first frame leg and the second frame leg. The bearing assembly is at the multi-leg solar tracker support frame, and the bearing assembly is configured to support a torque tube. The bearing assembly includes a bearing sleeve and a torque tube connector. The bearing sleeve includes a first bearing sleeve portion and a hanging bearing sleeve portion. The first bearing sleeve portion interfaces with the bridge, and the hanging bearing sleeve portion extends out from the first bearing sleeve portion below the bridge. The torque tube connector is configured to couple the torque tube to the bearing assembly at least at the hanging bearing sleeve portion below the bridge.

In a further embodiment of this assembly, the first bearing sleeve portion includes a circular bearing body that wraps around at least a portion of the bridge. As one such example, the circular bearing body wraps around all of a perimeter surface of the bridge. In some embodiments, the torque tube connector is received at the hanging bearing sleeve portion below the bridge. In one such example, the first bearing sleeve portion can define an apex at the multi-leg solar tracker support frame. The hanging bearing sleeve portion can include a torque tube connector receptacle below the bridge and extending from one side of the bridge to another, opposite side of the bridge. The torque tube connector receptacle can be integral with the circular bearing body.

For certain embodiments, the torque tube connector can include a pin. In one such example, the assembly can further include a U-bolt that couples the pin to the torque tube. For example, the pin can extend through the torque tube connector receptacle, and the pin can couple to a pin aperture at the U-bolt.

In a further embodiment of this assembly, the bridge includes a corrugated bridge portion at least where the first bearing sleeve portion interfaces with the bridge. For example, the corrugated bridge portion can be configured to impart a degree of flexibility at the bridge such that the bridge is configured to adjust in length at the corrugated bridge portion. In one such example, the corrugated bridge portion can be configured to permit the first bearing sleeve portion to rotate relative to the bridge along a north-south axis and configured to prevent the first bearing sleeve portion from translating relative to the bridge along an east-west axis.

In a further embodiment of this assembly, the bridge includes a height adjustment portion at least where the first bearing sleeve portion interfaces with the bridge. For example, the height adjustment portion can be configured to rotate relative to first and second frame legs between a first bridge height position and a second bridge height position, and where the first bearing sleeve portion interfaces with the bridge is at a greater elevation relative to a ground surface at the first bridge height position than at the second bridge height position.

In a further embodiment of this assembly, the assembly additionally includes a first damper mount and a second damper mount. The first damper mount is at the first frame leg, and the first damper mount has a first sidewall in a first plane that includes the first frame leg and a second sidewall that curves outward from the first plane. The second damper mount is at the second frame leg, and the second damper mount has a third sidewall in a second plane that includes the second frame leg and a fourth sidewall that curves outward from the second plane.

In a further embodiment of this assembly, at least one of the first frame leg and the second frame leg includes a leg angular adjustment adapter. The leg angular adjustment adapter can be configured to change an orientation of the at least one of the first frame leg and the second frame leg relative to a ground surface. For example, the leg angular adjustment adapter can be configured to change the orientation of the at least one of the first frame leg and the second frame leg relative to the ground surface in a north-south direction relative to the ground surface. In certain such examples, the first frame leg can include a foundation connector that is configured to couple to a foundation component embedded in the ground surface, and the leg angular adjustment adapter can be at the foundation connector at the first frame leg.

Another embodiment disclosed herein includes a bearing assembly configured to support a torque tube of a solar tracker. This bearing assembly embodiment includes a bearing sleeve and a torque tube connector. The bearing sleeve includes a first bearing sleeve portion and a hanging bearing sleeve portion. The first bearing sleeve portion is configured to interface with a bridge portion of a multi-leg solar tracker support frame to define an apex at the multi-leg solar tracker support frame when the bearing assembly is coupled to the multi-leg solar tracker support frame. The hanging bearing sleeve portion extends out below the first bearing sleeve portion when the bearing assembly is coupled to the multi-leg solar tracker support frame. The torque tube connector is configured to be received at the hanging bearing sleeve portion. The torque tube connector is configured to couple the torque tube to the bearing assembly at the hanging bearing sleeve portion below the bridge.

The details of one or more examples are set forth in the accompanying drawings and the description below. Other features, objects, and advantages will be apparent from the description and drawings, and from the claims.

### BRIEF DESCRIPTION OF DRAWINGS

The following drawings are illustrative of particular examples of the present invention and therefore do not limit the scope of the invention. The drawings are intended for use in conjunction with the explanations in the following detailed description wherein like reference characters denote like elements. Examples of the present invention will hereinafter be described in conjunction with the appended drawings.

FIG. 1 is a schematic, elevational view diagram of a solar tracker system that includes a plurality of solar tracker support frame assemblies.

FIGS. 2A-2B illustrate one exemplary embodiment of a multi-leg solar tracker support frame and bearing assembly coupled to a torque tube of a solar tracker system. FIG. 2A is a perspective, exploded view of the bearing assembly relative to the multi-leg solar tracker support frame. FIG. 2B is perspective view of the bearing assembly of FIG. 2A assembled at, and coupled to, a bridge of the multi-leg solar tracker support frame.

FIG. 3 is an elevational view of another embodiment of a bearing assembly coupled to a bridge of a multi-leg solar tracker support frame.

FIG. 4 is an elevational view of another embodiment of a bearing assembly coupled to a bridge of a multi-leg solar tracker support frame.

FIG. 5 is an elevational view of an embodiment of a bridge, having a corrugated bridge portion, for a multi-leg solar tracker support frame.

FIG. 6 is an elevational view of an embodiment of a bridge, having a height adjustment portion, for a multi-leg solar tracker support frame.

FIG. 7 is an elevational view of an embodiment of a bridge, having a lateral adjustment portion, for a multi-leg solar tracker support frame.

FIGS. 8A-8B illustrate one exemplary embodiment of a damper mount. FIG. 8A is a perspective view of the damper mount embodiment, and FIG. 8B is a plan view of the damper mount embodiment.

FIG. 9 is an elevation view of an embodiment of a leg adjustment adapter at a leg of a multi-leg solar tracker support frame shown exploded relative to a foundation component.

### DETAILED DESCRIPTION

The following detailed description is exemplary in nature and is not intended to limit the scope, applicability, or configuration of the invention in any way. Rather, the following description provides some practical illustrations for implementing examples of the present invention. Those skilled in the art will recognize that many of the noted examples have a variety of suitable alternatives.

Embodiments disclosed herein include various devices, systems, and methods relating to solar tracker support frame assemblies and bearing assemblies. Such embodiments disclosed herein include solar tracker support frame assemblies having a multi-leg solar tracker support frame and a bearing assembly at the multi-leg solar tracker support frame. Certain such embodiments disclosed herein relate to a multi-leg solar tracker support frame (e.g., a solar tracker A-frame) that can be adjusted relative to a ground surface. Certain such additional or alternative embodiments disclosed herein relate to a bearing assembly that is configured to be mounted at a multi-leg solar tracker support frame to position a torque tube at the bearing assembly below an apex at the multi-leg solar tracker support frame (e.g., below a bridge of the multi-leg solar tracker support frame). These embodiments can be useful in reducing cost, time, and labor associated with installing a solar tracker system in the field.

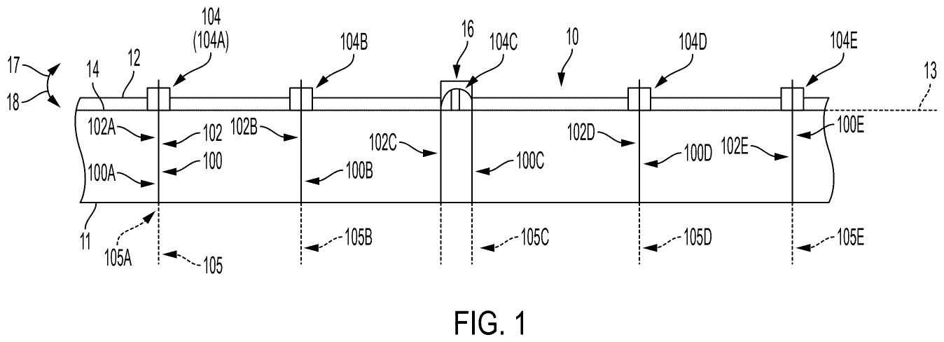

FIG. 1 is a schematic, elevational view diagram of a solar tracker system 10. The solar tracker system 10 includes a torque tube 14 and a plurality of solar modules 12 that are coupled to the torque tube 14 to thereby rotate with the torque tube 14. The system 10 can further include a motive source 16 that is coupled to the torque tube 14 to impart a rotational motive force (e.g., torque) to the torque tube 14 to cause the torque tube 14 to rotation in a direction 17 and in an opposite direction 18. The system 10 can be configured to rotate the torque tube 14 in directions 17, 18 over time to change the orientation of the solar modules 12 relative to the sun.

Each of the one of more solar modules 12 can include a frame and a plurality of photovoltaic cells that are configured to receive sunlight and as a result generate electrical energy. A module mounting assembly can connect at least one solar module 12 to the torque tube 14, and the torque tube can be configured to rotatably move one or more such solar modules 12. For instance, the torque tube 14 can be actuated by a controller (e.g., that is in communication with the motive source 16) to cause the torque tube 14 to move, such as rotate about a longitudinal axis 13 of the torque tube 14. Rotation of the torque tube 14 in the directions 17 and/or 18 can facilitate more optimized solar power generation at the photovoltaic cells at the solar modules 12 by adjusting the angle of the one or more solar modules at one or more times (e.g., at times during a given day) to help “track” the sun as it moves over that period of time and, thereby, maintain more optimized positioning of the photovoltaic cells relative to the angle of sunlight irradiation at that given time of the day.

To support the torque tube 14, the system 10 can include a plurality of solar tracker support frame assemblies 100. The embodiment illustrated at FIG. 1 shows a plurality of solar tracker support frame assemblies 100A, 100B, 100C, 100D, 100E each rotatably supporting torque tube 14. Each solar tracker support frame assembly 100 can include a multi-leg solar tracker support frame 102 and a bearing assembly 104 (e.g., certain embodiment of which can be referred to as a hanging bearing assembly). Thus, as shown at the example of FIG. 1, the solar tracker support frame assembly 100A includes the multi-leg solar tracker support frame 102A and the bearing assembly 104A, the solar tracker support frame assembly 100B includes the multi-leg solar tracker support frame 102B and the bearing assembly 104B, the solar tracker support frame assembly 100C includes the multi-leg solar tracker support frame 102C and the bearing assembly 104C, the solar tracker support frame assembly 100D includes the multi-leg solar tracker support frame 102D and the bearing assembly 104D, and the solar tracker support frame assembly 100E includes the multi-leg solar tracker support frame 102E and the bearing assembly 104E. The respective bearing assemblies 104A-104E at each solar tracker support frame assembly 100A-100E can receive and rotatably support the torque tube 14 thereat. Thus, the torque tube 14 can rotate in the directions 17, 18 while rotatably supported at each of the bearing assemblies 104A-104E. The respective multi-leg solar tracker support frame 102A-102E at each solar tracker support frame assembly 100A-100E can couple to the respective bearing assembly 104A-104E.

Each of the respective multi-leg solar tracker support frames 102A-102E can be supported at a ground surface 11 via a foundation component 105. As shown at FIG. 1, the multi-leg solar tracker support frame 102A is supported at ground surface 11 via foundation component 105A, the multi-leg solar tracker support frame 102B is supported at ground surface 11 via foundation component 105B, the multi-leg solar tracker support frame 102C is supported at ground surface 11 via foundation component 105C, the multi-leg solar tracker support frame 102D is supported at ground surface 11 via foundation component 105D, and the multi-leg solar tracker support frame 102E is supported at ground surface 11 via foundation component 105E. The foundation components 105A-105E can extend into and below ground surface 11 so as to be embedded into the ground surface 11 to support the above-ground, respective multi-leg solar tracker support frame 102A-102E and associated respective bearing assembly 104A-104E. The foundation components 105A-105E can, for example, one or more blade piles (e.g., a pair of blade piles), one or more screw piles (e.g., a pair of screw piles), and/or one or more concrete footings (e.g., a pair of concrete footings) as examples.

FIG. 1 shows the system 10 at a side elevational view looking in an east-west orientation at the multi-leg solar tracker support frames 102A-102E and associated bearing assemblies 104A-104E. As illustrated, the multi-leg solar tracker support frames 102A, 102B, 102D, 102E and associated bearing assemblies 104A, 104B, 104D, 104E can be oriented in one direction, while the multi-leg solar tracker support frame 102C associated bearing assembly 104C can be oriented in a different direction, such as generally ninety degrees offset from the multi-leg solar tracker support frames 102A, 102B, 102D, 102E. For instance, the multi-leg solar tracker support frames 102A, 102B, 102D, 102E and associated bearing assemblies 104A, 104B, 104D, 104E can face one of east-west and north-south while the multi-leg solar tracker support frame 102C and associated bearing assembly 104C can face the other of east-west and north-south.

Installing a typical solar tracker system in the field can oftentimes necessitate a significant number of interconnections between a significant number of components ranging from subterranean foundation components and connections to above-ground bearing connections and solar module support connections. The solar tracker support frame assembly 100 embodiments disclosed herein can be useful in reducing the cost, time, and labor associated with installing a solar tracker system in the field. For example, such embodiments disclosed herein can be adapted for use with a wide variety of foundation types, can help to reduce the cost of solar tracker installation in the field by reducing a number of components and inter-component connections and fastening members necessary to effectively couple a torque tube of a solar tracker system to a bearing assembly that is supported by a multi-leg solar tracker support frame at a foundation, and/or can include the bearing assembly configured to be mounted at a multi-leg solar tracker support frame to position a torque tube at the bearing assembly below an apex at the multi-leg solar tracker support frame to thereby help to reduce the magnitude of dynamic loads (e.g., wind loads) transferred to the foundation component by the bearing assembly.

For example, to help reduce cost, time, and labor associated with installing a solar tracker system in the field, embodiments disclosed herein can include solar tracker support frame assemblies having a multi-leg solar tracker support frame and a bearing assembly at the multi-leg solar tracker support frame. The multi-leg solar tracker support frame (e.g., a solar tracker A-frame) can be adjusted relative to a ground surface and/or the bearing assembly is configured to be mounted at a multi-leg solar tracker support frame to position a torque tube at the bearing assembly below an apex at the multi-leg solar tracker support frame (e.g., below a bridge of the multi-leg solar tracker support frame).

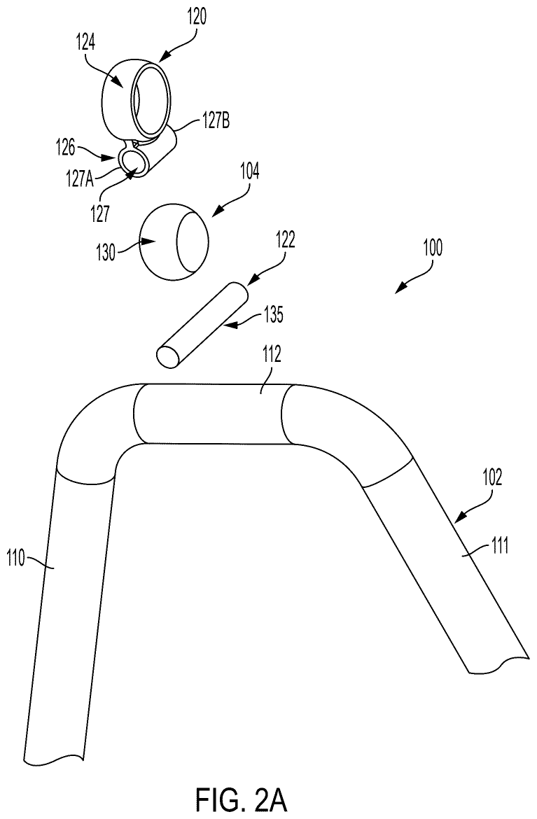

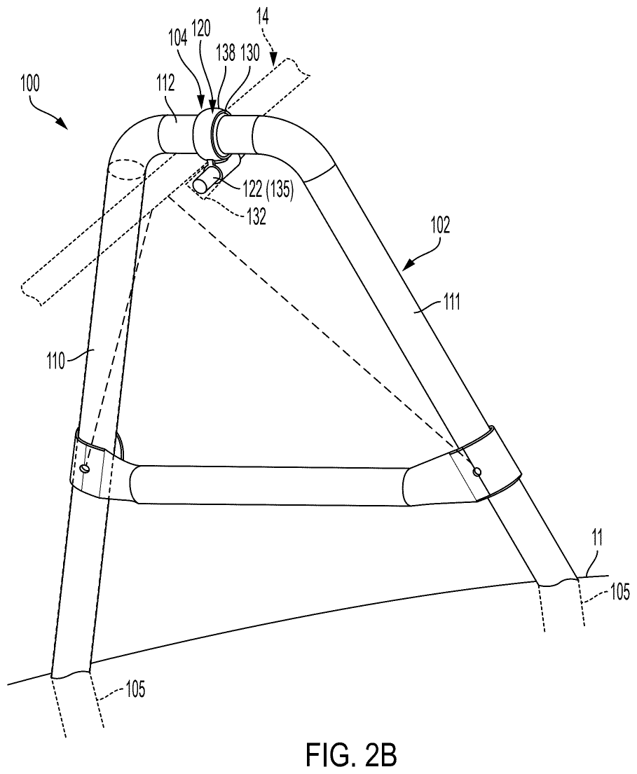

FIGS. 2A-2B illustrate one exemplary embodiment of multi-leg solar tracker support frame 102 and bearing assembly 104 coupled to torque tube 14 of a solar tracker system, such as, for example, that shown at FIG. 1. FIG. 2A is a perspective, exploded view of the bearing assembly 104 relative to the multi-leg solar tracker support frame 102. FIG. 2B is perspective view of the bearing assembly 104 assembled at, and coupled to, the multi-leg solar tracker support frame 102 (e.g., at a bridge of the frame 102). As noted with respect to FIG. 1, together, the multi-leg solar tracker support frame 102 and bearing assembly 104 can form solar tracker support frame assembly 100.

The solar tracker support frame assembly 100 includes the multi-leg solar tracker support frame 102 and the bearing assembly 104. The solar tracker support frame assembly 100 can be supported at ground surface 11 via one or more foundation components 105. As shown at FIG. 1, the solar tracker support frame assembly 100 can be supported at ground surface 11 via a pair of foundation components 105. The one or more foundation components 105 can extend into and below ground surface 11 to anchor the solar tracker support frame assembly 100 to the ground surface 11. The one or more foundation components 105 can be any of a variety of types of suitable subterranean anchor components that can be embedded in the ground and coupled to the solar tracker support frame assembly 100.

The multi-leg solar tracker support frame 102 can include a first frame leg 110, a second frame leg 111, and a bridge 112 extending between the first frame leg 110 and the second frame leg 111. The first frame leg 110 and the second frame leg 111 can be supported at the ground surface 11 via foundation component 105 that is at least partially embedded within the ground surface 11. As shown for the illustrated example, the first frame leg 110 can be supported at a first foundation component 105 that is at least partially embedded within the ground surface 11 while the second frame leg 111 can be supported at a second, different foundation component 105 that is at least partially embedded within the ground surface 11. The bridge 112 can bridge between and interconnect the first and second frame legs 110, 111. In some examples, the multi-leg solar tracker support frame 102 can have the first frame leg 110, the second frame leg 111, and the bridge 112 as integral components defining a single piece body at the multi-leg solar tracker support frame 102, though in other examples the multi-leg solar tracker support frame 102 can have the first frame leg 110, the second frame leg 111, and the bridge 112 as individual components that are fastened together, such as via the bridge 112. The one or more foundation components 105 can be inserted (e.g., rammed, rotationally driven, etc.) into ground surface 11 and then the multi-leg solar tracker support frame 102 can be coupled to the ground embedded one or more foundation components 105.

The bearing assembly 104 can be at the multi-leg solar tracker support frame 102. The bearing assembly 104 can be configured to support the torque tube 14 such that the torque tube 14 is supported via the ground surface 11 by the foundation component(s) 105, the multi-leg solar tracker support frame 102, and the bearing assembly 104. For example, the bearing assembly 104 can be configured to rotatably support the torque tube 14 thereat such that the torque tube 14 can rotate relative to the bearing assembly 104 to change an orientation of solar modules relative to the sun. The bearing assembly 104 can include a bearing sleeve 120 and a torque tube connector 122. The bearing sleeve 120 can be configured to suspend the torque tube connector 122 from the multi-leg solar tracker support frame 102, and the suspended torque tube connector 122 can be configured to couple to the torque tube 14 so as to rotatably support the torque tube 14 at the bearing assembly 104. As shown for the illustrated example at FIG. 2B, the torque tube 14 can be suspended from the bearing assembly 104 below the bridge 112 such that the torque tube 14 passes between the legs 110, 111 as the torque tube 14 passes under the bridge 112.

The bearing sleeve 120 at the bearing assembly 104 can include a first bearing sleeve portion 124 and a hanging bearing sleeve portion 126. The first bearing sleeve portion 124 can be configured to interface with the bridge 112, and the hanging bearing sleeve portion 126 can be configured to extend out from the first bearing sleeve portion 124 below the bridge 112. The illustrated embodiment shows that the first bearing sleeve portion 124 can wrap around at least a portion of the bridge 112. For instance, as shown best at the example of FIG. 2B, the first bearing sleeve portion 124 can be configured to wrap around at least half of a perimeter surface 113 of the bridge 112. The illustrated embodiment of the first bearing sleeve portion 124 includes a circular bearing body that is configured to wrap around at least a portion of the bridge 112, such as to wrap circumferentially around all of, such as a three hundred and sixty degrees circumference at an outer perimeter surface at, the bridge 112 along at least a portion of the length of the bridge 112. As shown at the example of FIG. 2B, the first bearing sleeve portion 124 can define an apex 138 at the multi-leg solar tracker support frame 102 such that the apex 138 at the first bearing sleeve portion 124 is at a height relative to the ground surface 11 above a highest elevation portion of the multi-leg solar tracker support frame 102. The hanging bearing sleeve portion 126 can be configured to couple to the torque tube connector 122 so as to couple the torque tube 14 to the bearing sleeve 120 at the hanging bearing sleeve portion 126. As such, the torque tube connector 122 can be configured to be received at the hanging bearing sleeve portion 126 of the bearing assembly 104. For instance, as shown for the example here, the torque tube connector 122 can be configured to couple the torque tube 14 to the bearing assembly 104 at least at the hanging bearing sleeve portion 126 below the bridge 112 of the multi-leg solar tracker support frame 102.

For example, the illustrated embodiment of the hanging bearing sleeve portion 126 includes a torque tube connector receptacle 127. The torque tube connector receptacle 127 can be below and extend out from the first bearing sleeve portion 124. For instance, for some embodiments the torque tube connector receptacle 127 can be integral with the circular bearing body that forms the first bearing sleeve portion 124. The torque tube connector receptacle 127 can define a first receptacle opening 127A at a first side of the torque tube connector receptacle 127 and a second receptacle opening 127B at a second, opposite side of the torque tube connector receptacle 127. Thus, when the bearing assembly 104 is coupled to the bridge 112, the torque tube connector receptacle 127 can be below the bridge 112 and the torque tube connector receptacle 127 can extend from one side of the bridge 112 to another, opposite side of the bridge 112. And, when the bearing assembly 104 is coupled to the bridge 112, the first receptacle opening 127A can be below the bridge 112 at one side of the bridge 112 while the second receptacle opening 127B is below the bridge at another, opposite side of the bridge 112. Thus, the torque tube connector receptacle 127 can be configured to receive the torque tube connector 122 such that the torque tube connector 122 extends through the first and second receptacle openings 127A, 127B at the hanging bearing sleeve portion 126 below the bridge 112 of the multi-leg solar tracker support frame 102.

In some embodiments, the bearing assembly 104 can further include a bushing 130. The bushing 130 can be configured to interface with the bridge 112. In one more specific embodiment shown here, the bushing 130 can be configured to interface with the bridge 112 at one side of the bushing 130 and to interface with the bearing sleeve 120 at another, opposite side of the bushing 130. In particular, as shown at FIG. 2B, the bushing 130 can be configured to contact the bridge 112 at one side of the bushing 130 and to contact the first bearing sleeve portion 124 of the bearing sleeve 120 at another, opposite side of the bushing 130. The bushing 130 can be configured to rotate relative to the bridge 112 and, as such, can be configured to provide a rotational interface between the bearing sleeve 120 (e.g., the first bearing sleeve portion 124) and the bridge 112.

The torque tube connector 122 of the illustrated embodiment of the bearing assembly 104 includes a pin 135. As also shown for the illustrated embodiment at FIG. 2B, the solar tracker support frame assembly 100 can also include a U-bolt 132. The U-bolt 132 can be configured to receive and couple the pin 135 to the torque tube 14. For example, the pin 135 can extend through the first receptacle opening 127A at the hanging bearing sleeve portion 126 below the bridge 112, at a first side of bridge 112, and extend through the second receptacle opening 127B at the hanging bearing sleeve portion 126 below the bridge 112, at a second, opposite side of bridge 112 such that the pin 135 passes under bridge 112. The U-bolt 132 can receive and couple to the pin 135 via a pin aperture at the U-bolt 132. As seen at the examples at FIG. 2B, the pin 135 can extend along a pin longitudinal axis that is offset from central longitudinal axis 13 of torque tube 14 (e.g., with torque tube central longitudinal axis 13 being the rotational axis of torque tube 14).

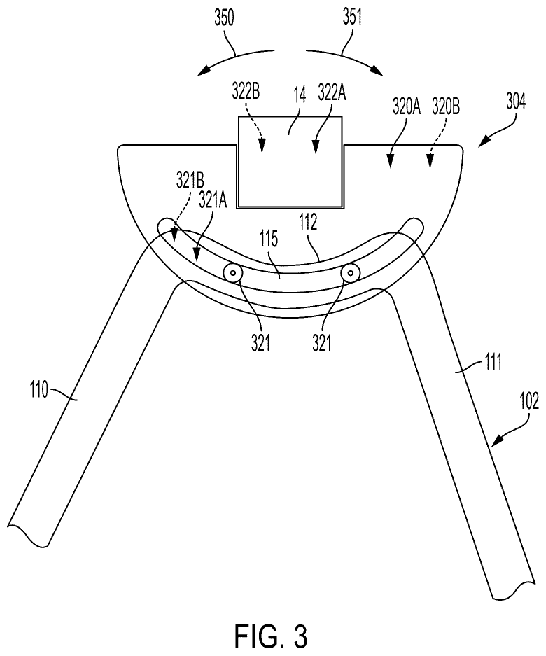

FIG. 3 is an elevational view of another embodiment of a bearing assembly 304 that is configured to couple to bridge 112 of multi-leg solar tracker support frame 102.

The bearing assembly 304 can include a first bearing plate 320A, a second bearing plate 320B, and at least one bearing roller 321. For the view illustrated at FIG. 3, the first and second bearing plates 320A, 320B are axially aligned such that the second bearing plate 320B is shown behind, and hidden by, the first bearing plate 320A. The first bearing plate 320A can be configured to couple to the multi-leg solar tracker support frame 102 at one side of bridge 112, and the second bearing plate 320B can be configured to couple to the multi-leg solar tracker support frame 102 at another, opposite side of bridge 112. Thus, bridge 112, can be positioned between the first and second bearing plates 320A, 320B. The first bearing plate 320A can define a first plate roller slot 321A, and the second bearing plate 320B can define a second plate roller slot 321B. As shown at FIG. 3, the first and second bearing plates 320A, 320B can be coupled to the multi-leg solar tracker support frame 102 such that the first plate roller slot 321A is aligned with the second plate roller slot 321B.

The first bearing plate 320A and the second bearing plate 320B can be configured to receive the torque tube 14. For example, first bearing plate 320A can include first torque tube receiving aperture 322A that is configured to receive and support torque tube 14, and the second bearing plate 320B can include second torque tube receiving aperture 322B that is configured to receive and support torque tube 14. The first bearing plate 320A and the second bearing plate 320B can be coupled to the multi-leg solar tracker support frame 102 (e.g., coupled to bridge 112) such that the first torque tube receiving aperture 322A is axially aligned with the second torque tube receiving aperture 322B.

The bearing assembly 304 can be configured to rotate relative to the multi-leg solar tracker support frame 102. Namely, as the torque tube 14 is rotated, the bearing assembly 304 is caused to rotate along with the torque tube 14 such that the bearing assembly 304 rotates with torque tube 14 relative to the multi-leg solar tracker support frame 102 (e.g., relative to bridge 112). For example, the bearing assembly 304 can be configured to rotate relative to the multi-leg solar tracker support frame 102 in direction 350 and/or in direction 351. More specifically, the bearing assembly 304 can be configured to rotate relative to the bridge 112 of the multi-leg solar tracker support frame 102 in direction 350 and/or in direction 351. To help configure the bearing assembly 304 to rotate relative to the bridge 112, the bridge 112 can include a bearing roller slot 115. As shown at FIG. 3, the first bearing plate 320A and the second bearing plate 320B can be coupled to the bridge 112 such that the first plate roller slot 321A and the second plate roller slot 321B are aligned with the bearing roller slot 115 at the bridge 112.

The at least one bearing roller 321 can be configured to rotate the bearing assembly 304 relative to the multi-leg solar tracker support frame 102 in the direction 350 and/or 351. The at least one bearing roller 321 can be received at the first plate roller slot 321A at each of the first bearing plate 320A, the second plate roller slot 321B at the second bearing plate 320B, and the bearing roller slot 115 at the bridge 112. The at least one bearing roller 321 can be configured to move relative to the bearing roller slot 115 at the bridge 112 to move (e.g. rotate) the bearing assembly 304 relative to the multi-leg solar tracker support frame 102. Namely, the at least one bearing roller 321 can be configured to move relative to the bearing roller slot 115 at the bridge 112 to move (e.g. rotate) the first and second bearing plates 320A, 320B with the associated torque tube 14. The illustrated embodiment shows a pair of such bearing rollers 321. As one example, each of the at least one bearing roller 321 can include a first roller member at least at the first roller plate slot 321A at the first bearing plate 320A and at the bearing roller lost 114 at the bridge 112 and second roller member at least at the second roller plate slot 321B at the second bearing plate 320B and at the bearing roller lost 114 at the bridge 112, with a through fastener (e.g., bolt, blind rivet, etc.) extending at and interconnecting such first and second roller members. The geometric shape of the first roller plate slot 321A, second roller plate slot 321B, and bearing roller slot 115 can correspond to a cross-sectional geometric shape of the at least one bearing roller 321. For example, each of the geometric shape of the first roller plate slot 321A, second roller plate slot 321B, and bearing roller slot 115 can include a semi-circular arc that enables torque tube 14 rotation to at least seventy degrees in the direction 350 and to at least seventy degrees in the direction 351.

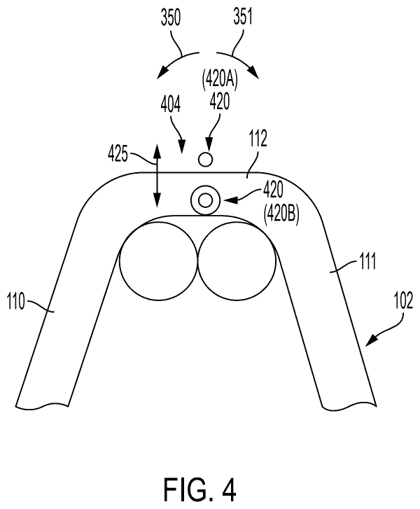

FIG. 4 is an elevational view of another embodiment of a bearing assembly 404 that is configured to couple to bridge 112 of multi-leg solar tracker support frame 102. The bearing assembly 404 can have one or more (e.g., each) of the features disclosed elsewhere herein for other bearing assembly embodiments except as otherwise noted here.

The bearing assembly 404 is configured to couple to bridge 112, as shown at the example of FIG. 4. The bearing assembly 404 can be configured to rotatably receive the torque tube of a solar tracker, and the bearing assembly 404 can be configured to adapt the torque tube for a predefined range of rotation about the torque tube's rotational axis. For example, the illustrated embodiment of the bearing assembly 404 is configured to adapt the torque tube for a ±70 degrees predefined range of rotation about the torque tube's rotational axis. Namely, the illustrated embodiment of the bearing assembly 404 is configured to adapt the torque tube for up to 70 degrees of rotation in the direction 350, and the bearing assembly 404 is configured to adapt the torque tube for up to 70 degrees of rotation in the opposite direction 351. Other embodiments can similarly be configured for other predefined ranges of rotation, such as ±60 degrees, ±65 degrees, ±75 degrees, or ±80 degrees.

To configure to bearing assembly 404 to prevent further rotation of the torque tube beyond the predefined range of rotation, the bearing assembly 404 can include one or more rotation range confinement members 420. For example, the bearing assembly 404 can include a first rotation range confinement member 420A and a second rotation range confinement member 420B that is spaced apart from the first rotation confinement member 420A by a distance 425. A complementary portion of the bearing assembly 403, torque tube, or other component and be disposed between the first and second range confinement members 420A, 420B such that upon contact the first and second range confinement members 420A, 420B impede or prevent further incremental rotation in the same rotational direction. As shown here, the first and second range confinement members 420A, 420B can be axially aligned at the bridge 112, and, as one example, the first and second range confinement members 420A, 420B can be axially aligned on a common axis that also intersects the torque tube. The distance 425 between the first and second range confinement members 420A, 420B can vary depending on the specific predefined range of rotation for which the first and second range confinement members 420A, 420B are to provide a hard stop to maintain torque tube rotation confined within the predefined range of rotation for the torque tube.

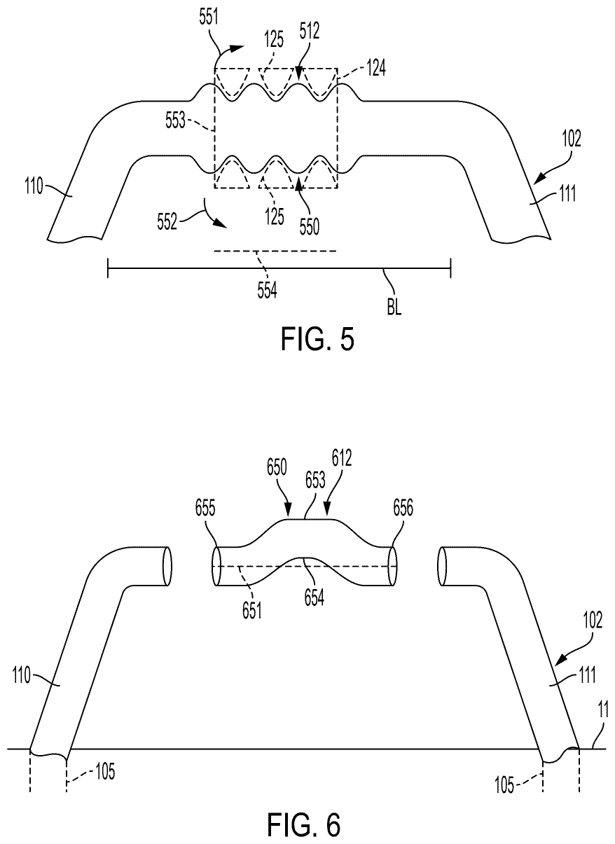

FIG. 5 is an elevational view of an embodiment of a bridge 512, having a corrugated bridge portion 550. For some embodiments, the bridge 512 can be similar to, or the same as, the bridge 112 disclosed elsewhere herein except as otherwise noted here. The bridge 512 can be configured as a bridge for multi-leg solar tracker support frame 102, such as disclosed elsewhere herein. Namely, bridge 512 can bridge between and interconnect the first and second frame legs 110, 111.

As noted, the bridge 512 can include corrugated bridge portion 550. The corrugated bridge portion 550 can be at the bridge 512 at least where the first bearing sleeve portion (e.g., the first bearing sleeve portion 124) interfaces with the bridge 512. Thus, the first bearing sleeve portion of a bearing assembly (e.g., the first bearing sleeve portion 124 of the bearing assembly 104) can be placed at the corrugated bridge portion 550. The corrugated bridge portion 550 can be configured to impart a degree of flexibility at the bridge 512 such that the bridge 512 can be configured to adjust in bridge length BL at the corrugated bridge portion 550. For example, the corrugated bridge portion 550 can initially define a first bridge length BL for the bridge 512, and then when the corrugated bridge portion 550 is deformed, the corrugated bridge portion 550 can be configured to increase the length of the bridge 512 to a second, longer bridge length BL. Thus, the corrugated bridge portion 550 can be configured to adjust a length BL of the bridge 512 which can correspondingly adjust a magnitude of spacing between the legs 110, 111. Thus, upon a deformation force applied at the bridge 512, the corrugated bridge portion 550 can be configured to expand to increase the bridge length BL which correspondingly acts to increase a spacing between the legs 110, 111.

As noted, the corrugated bridge portion 550 can be configured to couple to a bearing assembly, such as an embodiment of a bearing assembly disclosed elsewhere herein. FIG. 5 shows one example where the corrugated bridge portion 550 is configured to couple to the first bearing sleeve portion 124 disclosed elsewhere herein. The corrugated bridge portion 550 can be configured to permit the first bearing sleeve portion 124 to rotate relative to the bridge 512. For example, the corrugated bridge portion 550 can be configured to permit the first bearing sleeve portion 124 to rotate relative to the bridge 512 in directions 551, 552 about a north-south axis 553 and configured to prevent the first bearing sleeve portion 124 from translating relative to the bridge 512 along an east-west axis 554. As one example to allow for this rotation of the first bearing sleeve portion 124 relative to the bridge 512 about the north-south axis 553 while preventing the first bearing sleeve portion 124 from translating relative to the bridge 512 along the east-west axis 554, the first bearing sleeve portion 124 can include grooves 125 that are complementary to grooves at the corrugated bridge portion 550. The grooves 125 at the first bearing sleeve portion 124 can intermesh with corresponding grooves at the corrugated bridge portion 550 to both permit rotation of the first bearing sleeve portion 124 about the corrugated bridge portion 550 on the north-south axis 553 while preventing the first bearing sleeve portion 124 from translating relative to the bridge 512 along the different, transverse east-west axis 554.

FIG. 6 is an elevational view of an embodiment of a bridge 612, having a height adjustment portion 650. For some embodiments, the bridge 612 can be similar to, or the same as, the bridge 112 disclosed elsewhere herein except as otherwise noted here. The bridge 612 can be configured as a bridge for multi-leg solar tracker support frame 102, such as disclosed elsewhere herein. Namely, bridge 612 can bridge between and interconnect the first and second frame legs 110, 111.

As noted, the bridge 612 can include the height adjustment portion 650. The height adjustment portion 650 can be at the bridge 612 at least where a bearing assembly (e.g., the first bearing sleeve portion 124 of the bearing assembly 104) interfaces with the bridge 612. Thus, the first bearing sleeve portion of a bearing assembly (e.g., the first bearing sleeve portion 124 of the bearing assembly 104) can be placed at the height adjustment portion 650.

The height adjustment portion 650 can be configured to rotate relative to first and second frame legs 110, 111 between a first bridge height position and a second bridge height position. Namely, the bridge 612 can define a bridge central longitudinal axis 651 extending centrally through a body of the bridge 612 between first bridge end 655 and second, opposite bridge end 656. As one example, the orientation shown at FIG. 6 can be such that the bridge central longitudinal axis 651 extends in an east-west direction such that the height adjustment portion 650 in configured to rotate relative to the legs 110, 111 about an east-west axis. The bridge central longitudinal axis 651 can intersect the first leg 110 at the first bridge end 655 and can intersect the second leg 111 at the second bridge end 656 as shown at the example of FIG. 6. The height adjustment portion 650 can include protruded bridge portion 653 which projects outward from the bridge central longitudinal axis 651 in a direction away from the bridge central longitudinal axis 651, and the height adjustment portion 650 can included indented bridge portion 654 which is recessed inward toward the bridge central longitudinal axis 651. As shown for the illustrated embodiment, the protruded bridge portion 653 can be at a same axial location along the bridge central longitudinal axis 651 as the indented bridge portion 654. The height adjustment portion 650 can be configured to rotate relative to the frame legs 110, 111 about the bridge central longitudinal axis 651. For example, the height adjustment portion 650 can be configured to rotate relative to the frame legs 110, 111 about the bridge central longitudinal axis 651 to the first bridge height position where the protruded bridge portion 653 faces away from ground surface 11 and the indented bridge portion 654 faces the ground surface 11. As such, when the first bearing sleeve portion (e.g., the first bearing sleeve portion 124) interfaces with the bridge 612 when the height adjustment portion 650 is at the first bridge height position with the protruded bridge portion 653 facing opposite the ground surface 11 (e.g., and at the first bridge height position with the indented bridge portion 654 facing ground surface 11), the first bearing sleeve portion can be at a greater elevation relative to ground surface 11 than when the height adjustment portion 650 is at the second bridge height position with the indented bridge portion 654 facing opposite the ground surface 11 (e.g., and at the second bridge height position with the protruded bridge portion 653 facing ground surface 11).

Thus, the height adjustment portion 650 at the bridge 612 can be configured to rotate relative to the legs 110, 111 so as to cause the elevation of the bridge 612 relative to ground surface 11 to change. In particular, depending on the embodiment of bearing assembly coupled to bridge 612, the height adjustment portion 650 can be configured to rotate relative to the legs 110, 111 to adjust a height of an apex of the bearing assembly coupled to the bridge 612 at the height adjustment portion 650.

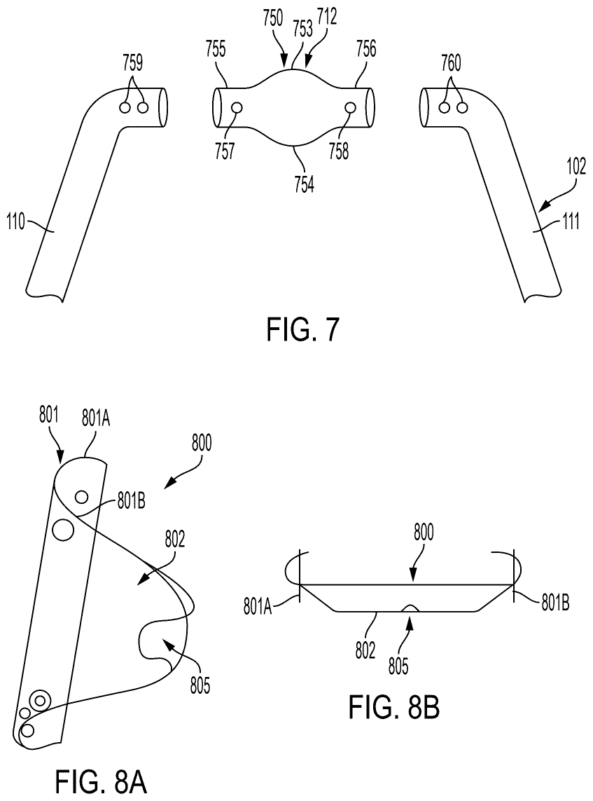

FIG. 7 is an elevational view of an embodiment of a bridge 712, having a lateral adjustment portion 750. For some embodiments, the bridge 712 can be similar to, or the same as, the bridge 112 disclosed elsewhere herein except as otherwise noted here. The bridge 712 can be configured as a bridge for multi-leg solar tracker support frame 102, such as disclosed elsewhere herein. Namely, bridge 712 can bridge between and interconnect the first and second frame legs 110, 111.

As noted, the bridge 712 can include the lateral adjustment portion 750. The lateral adjustment portion 750 can be at the bridge 712 at least where a bearing assembly (e.g., the first bearing sleeve portion 124 of the bearing assembly 104) interfaces with the bridge 712. Thus, the first bearing sleeve portion of a bearing assembly (e.g., the first bearing sleeve portion 124 of the bearing assembly 104) can be placed at the lateral adjustment portion 750.

The lateral adjustment portion 750 can be configured to translate relative to the legs 110, 111 to define a spacing between legs 110, 111. The lateral adjustment portion 750 can include a protruded upper portion 753 and a protruded lower portion 754 as well as a first bridge end 755 and a second, opposite bridge end 756. The protruded upper portion 753 and the protruded lower portion 754 can be between the first and second bridge ends 755, 756. The first bridge end 755 can include a first leg coupling aperture 757 (e.g., at the first bridge end 755 before the location of the protruded upper and lower portions 753, 754), and the second bridge end 756 can include a second leg coupling aperture 758 (e.g., at the second bridge end 756 before the location of the protruded upper and lower portions 753, 754). The leg 110 can include two or more first leg bridge coupling apertures 759, and the leg 111 can include two or more second leg bridge coupling apertures 760. The two or more first leg bridge coupling apertures 759 can be spaced apart from one another along an axis generally parallel to the ground surface, and the two or more second leg bridge coupling apertures 760 can be spaced apart from one another along an axis generally parallel to the ground surface. The first leg coupling aperture 757 can be configured to couple to one of the two or more first leg bridge coupling apertures 759, and the second leg coupling aperture 758 can be configured to couple to one of the two or more second leg bridge coupling apertures 760. Depending on which of the two or more first leg bridge coupling apertures 759 that the first leg coupling aperture 757, at the lateral adjustment portion 750, is coupled to and/or which of the two or more second leg bridge coupling apertures 760 that the second leg coupling aperture 758, at the lateral adjustment portion 750, is coupled to, the distance between the legs 110, 111 can differ. As such, the lateral adjustment portion 750 at the bridge 712 can be configured to change a spacing between adjacent legs 110, 111 of multi-leg solar tracker support frame 102.

FIGS. 8A-8B illustrate one exemplary embodiment of a damper mount 800. FIG. 8A is a perspective view of the damper mount 800, and FIG. 8B is a plan view of the damper mount 800. As one example, some embodiments can include a pair of damper mounts 800 at a multi-leg solar tracker support frame 102, with a first damper mount 800 of the pair at one leg 110 and other, second damper mount of the pair at another, leg 111 of the multi-leg solar tracker support frame 102.

Thus, the damper mount 800 can be configured to couple to a leg of the multi-leg solar tracker support frame 102. The damper mount 800 can include a first sidewall 801 in a first plane and a second sidewall 802 that curves outward from the first plane. The first plane within which the first sidewall 801 can sit can include a first leg (e.g., but not a second leg) of the multi-leg solar tracker support frame 102. Likewise, for the multi-leg solar tracker support frame 102, a second damper mount 800 can be included at a second leg such that this second damper mount has first sidewall 801 in a second plane within which the second leg can sit (e.g., but not the first leg).

The damper mount 800 can be configured to couple a damper to a respective leg of the multi-leg solar tracker support frame 102. The damper mount 800 can include a damper mount receptacle 805 at the second sidewall 802. As such, the damper mount receptacle 805 can be spaced apart from the first sidewall 801 and, thus, when the damper mount 800 is coupled to a leg at the first sidewall 801, the damper mount receptacle 805 at the second sidewall 802 can be spaced apart from, and extend out from, the leg at which the first sidewall 801 is coupled. As seen at FIG. 8B, for some embodiments the second sidewall 802 can wrap around a skewed axis that extends through the first sidewall 801. The damper mount receptacle 805 included at the second sidewall 802 which is offset from the interfacing leg of the support frame can be useful is providing a damper mounting configuration structurally adapted to couple a damper to a torque tube that is suspended below a bridge of the support frame.

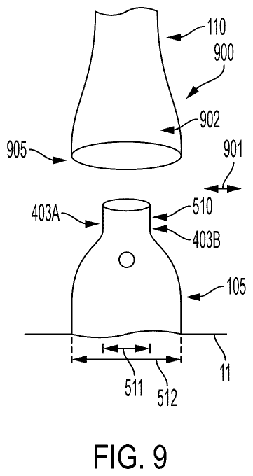

FIG. 9 is an elevation view of an embodiment of a leg adjustment adapter 900 at leg 110 of multi-leg solar tracker support frame 102. FIG. 9 shows the leg adjustment adapter 900 at leg 110 exploded relative to foundation component 105. In some embodiments of multi-leg solar tracker support frame 102, the leg adjustment adapter 900 can be included at each of first leg 110 and second leg 111 (a first leg adjustment adapter 900 at first leg 110 and a second leg adjustment adapter 900 at second leg 111).

The leg adjustment adapter 900 can be configured to change an angular orientation of the at least one of the first frame leg 110 and the second frame leg 111 relative to ground surface 11. For example, the leg angular adjustment adapter 900 can be configured to change the angular orientation of the at least one of the first frame leg 110 and the second frame leg 111 relative to the ground surface 11 in a north-south direction 901 relative to the ground surface 11. For instance, referring to FIG. 9, the leg angular adjustment adapter 900 can be included at the leg 110 and/or leg 111 of any one or more of the multi-leg solar tracker support frames 102A, 102B, 102D, 102E to change the angular orientation of the at least one of the first frame leg 110 and the second frame leg 111 relative to the ground surface 11 in a north-south direction relative to the ground surface 11.

The illustrated embodiment of the leg angular adjustment adapter 900 includes movable (e.g., hinged) adapter component 902 that is integrated at a foundation connector 905 at the leg 110. The movable adapter component 902 can be configured to movably couple the leg 110 to the foundation component 105. As shown at the example at FIG. 9, the foundation component 105 can include complementary connector 510 having a first width 511, and the foundation connector 905 at the leg 110 can include the movable adapter component 902 having a second width 512. The illustrated embodiment of the leg angular adjustment adapter 900 has the second width 512 of movable adapter component 902 greater than the first width 511 of the complementary connector 510. As illustrated for the example at FIG. 9, the movable adapter component 902 can be seated over the complementary connector 510 and extend around the complementary connector 510 to hingedly connect the movable adapter component 902 to the complementary connector 510 (e.g., via a pin). The movable adapter component 902 can rotate relative to the complementary connector 510, and thus relative to the foundation component 105, in directions 901. When the movable adapter component 902 so rotates in the directions 901 to a preset angular orientation, a hard stop 403A and/or 403B at the complementary connector 510 can be configured to impede or prevent further rotation of the leg 110 in the directions 901 via interference contact between the respective hard stop 403A, 403B (e.g., depending on which of the directions 901) at the complementary connector 510, and an interior surface at the movable adapter component 902.

Various examples have been described. These and other examples are within the scope of the following claims.

What is claimed is:

1. A solar tracker support frame assembly comprising:
a multi-leg solar tracker support frame comprising a first frame leg, a second frame leg, and a bridge extending between the first frame leg and the second frame leg; and
a bearing assembly at the multi-leg solar tracker support frame, the bearing assembly configured to support a torque tube, the bearing assembly comprising a bearing sleeve and a torque tube connector,
wherein the bearing sleeve comprises a first bearing sleeve portion and a hanging bearing sleeve portion, the first bearing sleeve portion interfacing with the bridge, the hanging bearing sleeve portion extending out from the first bearing sleeve portion below the bridge, and
wherein the torque tube connector is configured to couple the torque tube to the bearing assembly at least at the hanging bearing sleeve portion below the bridge.

2. The assembly of claim 1, wherein the first bearing sleeve portion comprises a circular bearing body that wraps around at least a portion of the bridge.

3. The assembly of claim 2, wherein the circular bearing body wraps around all of a perimeter surface of the bridge.

4. The assembly of claim 2, wherein the torque tube connector is received at the hanging bearing sleeve portion below the bridge.

5. The assembly of claim 4, wherein the first bearing sleeve portion defines an apex at the multi-leg solar tracker support frame.

6. The assembly of claim 4, wherein the hanging bearing sleeve portion comprises a torque tube connector receptacle below the bridge and extending from one side of the bridge to another, opposite side of the bridge.

7. The assembly of claim 6, wherein the torque tube connector receptacle is integral with the circular bearing body.

8. The assembly of claim 7, wherein the torque tube connector comprises a pin.

9. The assembly of claim 8, further comprising:
a U-bolt that couples the pin to the torque tube.

10. The assembly of claim 9,
wherein the pin extends through the torque tube connector receptacle, and
wherein the pin couples to a pin aperture at the U-bolt.

11. The assembly of claim 1, wherein the bridge comprises a corrugated bridge portion at least where the first bearing sleeve portion interfaces with the bridge.

12. The assembly of claim 11, wherein the corrugated bridge portion is configured to impart a degree of flexibility at the bridge such that the bridge is configured to adjust in length at the corrugated bridge portion.

13. The assembly of claim 12, wherein the corrugated bridge portion is configured to permit the first bearing sleeve portion to rotate relative to the bridge along a north-south axis and configured to prevent the first bearing sleeve portion from translating relative to the bridge along an east-west axis.

14. The assembly of claim 1, wherein the bridge comprises a height adjustment portion at least where the first bearing sleeve portion interfaces with the bridge.

15. The assembly of claim 14, wherein the height adjustment portion is configured to rotate relative to first and second frame legs between a first bridge height position and a second bridge height position, and wherein where the first bearing sleeve portion interfaces with the bridge is at a greater elevation relative to a ground surface at the first bridge height position than at the second bridge height position.

16. The assembly of claim 1, further comprising:
a first damper mount at the first frame leg, the first damper mount having a first sidewall in a first plane that includes the first frame leg and a second sidewall that curves outward from the first plane;
a second damper mount at the second frame leg, the second damper mount having a third sidewall in a second plane that includes the second frame leg and a fourth sidewall that curves outward from the second plane.

17. The assembly of claim 1, wherein at least one of the first frame leg and the second frame leg comprises a leg angular adjustment adapter, the leg angular adjustment adapter configured to change an orientation of the at least one of the first frame leg and the second frame leg relative to a ground surface.

18. The assembly of claim 17, wherein the leg angular adjustment adapter is configured to change the orientation of the at least one of the first frame leg and the second frame leg relative to the ground surface in a north-south direction relative to the ground surface.

19. The assembly of claim 18, wherein the first frame leg comprises a foundation connector that is configured to couple to a foundation component embedded in the ground surface, and wherein the leg angular adjustment adapter is at the foundation connector at the first frame leg.

20. A bearing assembly configured to support a torque tube of a solar tracker, the bearing assembly comprising:
a bearing sleeve comprising a first bearing sleeve portion and a hanging bearing sleeve portion, the first bearing sleeve portion configured to interface with a bridge portion of a multi-leg solar tracker support frame to define an apex at the multi-leg solar tracker support frame when the bearing assembly is coupled to the multi-leg solar tracker support frame, the hanging bearing sleeve portion extending out below the first bearing sleeve portion when the bearing assembly is coupled to the multi-leg solar tracker support frame; and
a torque tube connector configured to be received at the hanging bearing sleeve portion, the torque tube connector configured to couple the torque tube to the bearing assembly at the hanging bearing sleeve portion below the bridge.
